(19) United States
(12) Patent Application Publication
(10) Pub. No.: US 2025/0292770 A1
(43) Pub. Date: Sep. 18, 2025

(54) SYSTEMS AND METHODS FOR USER INTERACTIONS

(71) Applicant: Datum Point Labs Inc., Jackson, WY (US)

(72) Inventors: MICHAEL ZACHARSKI, Pawling, NY (US); PATRICK NUNALLY, San Diego, CA (US)

(21) Appl. No.: 19/067,066

(22) Filed: Feb. 28, 2025

Related U.S. Application Data
(60) Provisional application No. 63/564,439, filed on Mar. 12, 2024.

(51) Int. Cl. G10L 15/22; G10L 15/08; G10L 15/16; G10L 15/30

(52) U.S. Cl. CPC G10L 15/22; G10L 15/16; G10L 15/30; G10L 2015/088

(57) ABSTRACT

Embodiments described herein provide systems and methods for user interactions. A system receives via a data interface, an audio file including a user interaction prompt. The system plays, via a speaker, the audio file. The system receives, via a sensor, an audio input. The system performs an interactive action based on a determination that the audio input is responsive to the user interaction prompt.

### CROSS-REFERENCED APPLICATIONS

This application claims priority to and benefit of U.S. Provisional Application No. 63/564,439 filed Mar. 12, 2024 and entitled “Systems and Methods for User Interactions,” which is incorporated by reference herein in its entirety.

### TECHNICAL FIELD

The embodiments relate generally to systems and methods for user interactions, and more specifically to systems and methods for interactions via audio.

### BACKGROUND

Advertisements and other forms of communication to a user are traditionally one-directional. For example, an advertisement played via a virtual radio station may provide information, but is unable to respond to a user interaction. Therefore, there is a need for improved systems and methods for user interactions.

### BRIEF DESCRIPTION OF THE DRAWINGS

FIG. 1 illustrates a framework for user interactions, according to some embodiments.

FIG. 2 is a simplified diagram illustrating a computing device implementing the framework described herein, according to some embodiments.

FIG. 3 is a simplified diagram illustrating a neural network structure, according to some embodiments.

FIG. 4 is a simplified block diagram of a networked system suitable for implementing the framework described herein.

FIG. 5 is an example logic flow diagram, according to some embodiments.

FIGS. 6A-6B are exemplary devices with digital avatar interfaces, according to some embodiments.

### DETAILED DESCRIPTION

Advertisements and other forms of communication to a user are traditionally one-directional. For example, an advertisement played via a virtual radio station may provide information, but is unable to respond to a user interaction.

In response to the need or improved systems and methods for user interactions, embodiments herein provide for user interaction via an audio and/or video interface. Embodiments described herein provide a number of benefits. For example, A device may only enable an audio sensor (e.g., microphone) at determined times in order to listen for a prompted response. Relaying information to a central server allows for additional information to be provided to a user that may not be possible or convenient to present via the usual interface. For example, an audio interface may be used for usual user interaction, but to send a coupon to a user, the communication to the central server may allow for a text message to be sent to the user with the coupon or other additional information. This best utilizes an existing interface while allowing for enhanced functionality. Transitioning into interaction with a virtual avatar allows for seamless continuation of service in response to an audio response from a user.

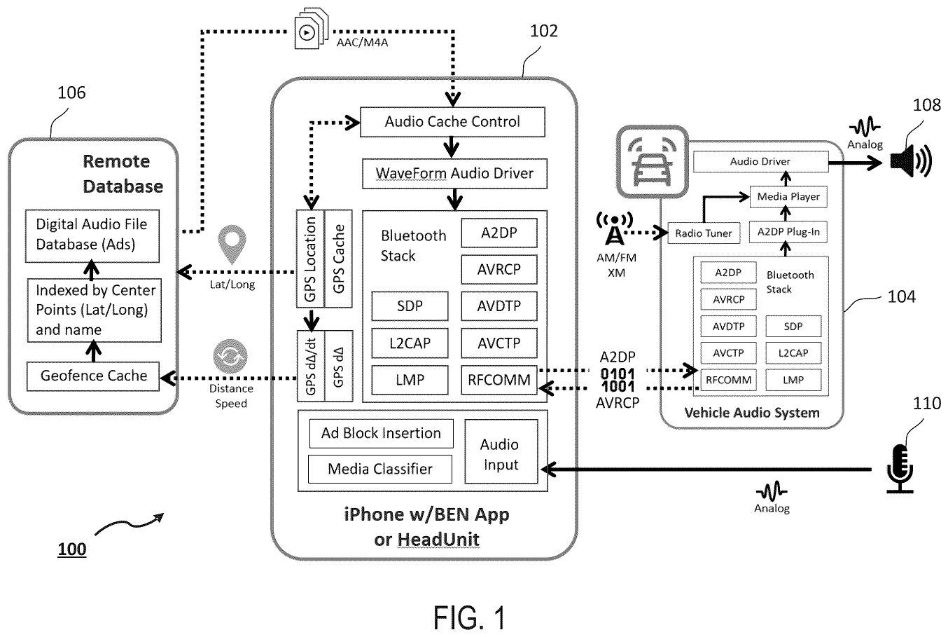

FIG. 1 illustrates an exemplary framework 100 for user interactions, according to some embodiments. Framework 100 illustrates a remote database 106, a user device 102, and a vehicle audio system 104. User device 102 may be a phone, a television, a tablet, or other user interface device. As illustrated, the vehicle audio system 104 may provide audio output 108, and user device 102 may provide an audio input device 110. In some embodiments, user device 102 may provide both audio input and output functions. In some embodiments, a vehicle audio system 104 may provide both audio input and output functions. Audio files may be provided by remote database 106 to user device 102. For example, audio files may include advertisements that include user interaction prompts. In response to hearing a prompt, user device 102 may enable the audio input device 110 and listen for a response to the prompt. User device 102 may determine if the response matches a predetermined expected response. For example, the determination may be performed by a neural network based speech-to-text model. In some embodiments, the model that performs the determination may be on a separate server and the user device 102 transmits the user audio input to the server. Based on the determination, user device 102 may perform an interactive action.

The interactive action may be a variety of things. For example, it may play an additional audio file, request additional information, etc. In some embodiments, the interactive action may be sending a message to a central server with a command. The command may be, for example, a command to send a text message to the user including specific information (e.g., a coupon). In some embodiments, multiple follow-up audio files may be played and associated audio inputs from the user may be received and acted upon. In some embodiments, a user response may activate an interactive chat interface so that the user can interact with an AI assistant. The AI assistant may be an audio-only interface, or in some embodiments may include a visual component such as a rendered virtual avatar persona.

In some embodiments, the interactive action includes pausing the audio that is playing. For example, the user may be listening to a virtual radio station via a radio application that is playing music. An ad may be interjected between songs, and the ad may include a prompt such as “for more information say ‘I want more info’.” If the user responds saying the prompted phrase, user device 102 may pause the music so that the user may continue interacting with the ad. In some embodiments, a specified website or other visual information may be displayed via user device 102 in response to the user response.

In some embodiments, the interactive action includes a request for additional information. For example, device 102 may request a phone number, location information, or other information from the user.

In some embodiments, audio files are received based on the location of user device 102 (e.g., as determined via GPS). For example, an advertisement for a local business may be delivered. The advertisement may include a prompt, and if the user responds to the prompt user device 102 may provide more information, cause for a separate server to deliver a coupon for the local business, etc.

In an example, an ad plays on a television and a user is watching TV from a streaming service provider. The ad is for widgets and at the end of the ad it says for more information say “Tell me more about widgets.” The user says that phrase and it then pauses the program and the user can talk back to the TV and ask some basic questions after which it asks if the user wants to provide contact info to set an appointment.

In another example, a user is listening to an audio streaming app in a car via Carplay and an audio ad plays “Today you can get 10% off at Burger King to get the offer you must say ‘I am the KING’ at the end of this commercial break.” The user says the phrase and it says “great tell me your phone number and we will text you the coupon.” The user says the phone number, and the device causes a text message to be sent to the phone number with the coupon.

In another example, a user in a car drives by a local store and through the car's native maps system it says “If you spend $25 or more on your purchase at CVS today you can get a $5.00 coupon-just say ‘CVS is there for me’ at the end of this ad.” If the user says the phrase, it asks for the users phone number to text them the coupon.

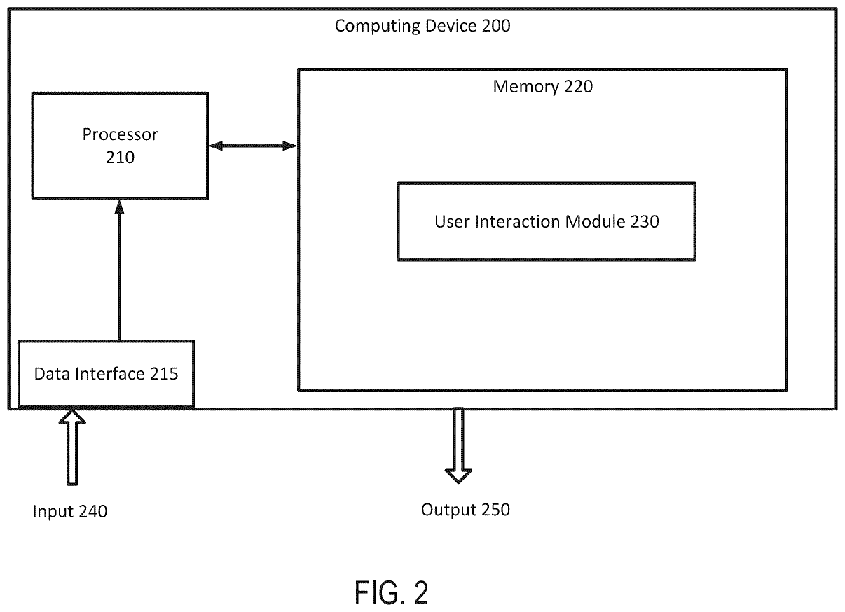

FIG. 2 is a simplified diagram illustrating a computing device 200 implementing the framework described herein, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of transitory or non-transitory machine-readable media (e.g., computer-readable media). Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for User interaction module 230 that may be used to implement and/or emulate the systems and models, and/or to implement any of the methods described further herein.

User interaction module 230 may receive input 240 such as audio files, audio inputs, etc. and generate an output 250 such as additional requested information, commands to a central server, etc. For example, User interaction module 230 may be configured to play audio files, and listen for user responses to the audio files, and perform actions in response to user input.

The data interface 215 may comprise a communication interface, a user interface (such as a voice input interface, a graphical user interface, and/or the like). For example, the computing device 200 may receive the input 240 from a networked device via a communication interface. Or the computing device 200 may receive the input 240, such as user input audio, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

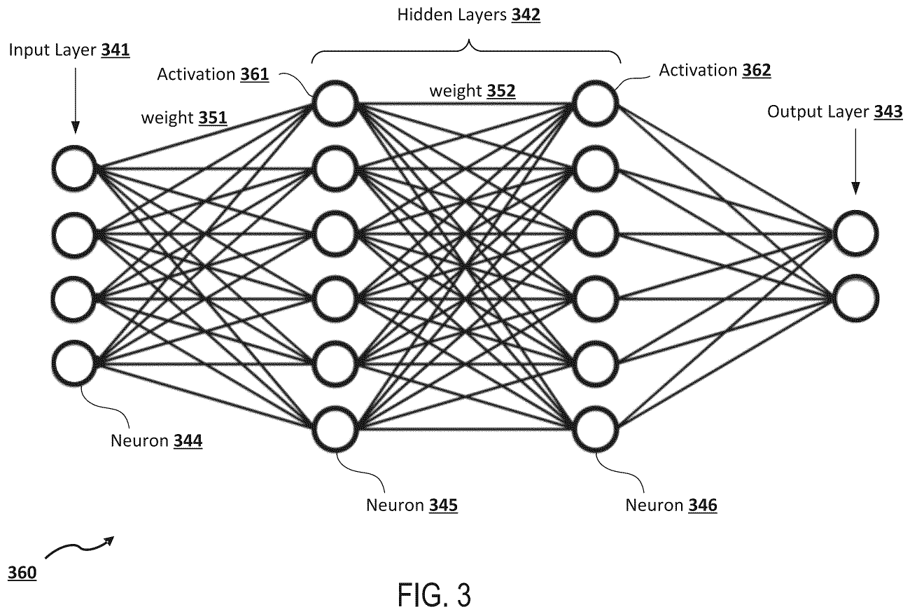

FIG. 3 is a simplified diagram illustrating the neural network structure, according to some embodiments. In some embodiments, the User interaction module 230 may be implemented at least partially via an artificial neural network structure shown in FIG. 3. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data such as training data, user input data, vectors representing latent features, etc. The number of nodes (neurons) in the input layer 341 may be determined by the dimensionality of the input data (e.g., the length of a vector of the input). Each node in the input layer represents a feature or attribute of the input.

The hidden layers 342 are intermediate layers between the input and output layers of a neural network. It is noted that two hidden layers 342 are shown in FIG. 3 for illustrative purpose only, and any number of hidden layers may be utilized in a neural network structure. Hidden layers 342 may extract and transform the input data through a series of weighted computations and activation functions.

For example, as discussed in FIG. 2, the User interaction module 230 receives an input 240 and transforms the input into an output 250. To perform the transformation, a neural network such as the one illustrated in FIG. 3 may be utilized to perform, at least in part, the transformation. Each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the User interaction module 230 may comprise the transformative neural network structure of layers of neurons, and weights and activation functions describing the non-linear transformation at each neuron. Such a neural network structure is often implemented on one or more hardware processors 210, such as a graphics processing unit (GPU).

In one embodiment, the User interaction module 230 may be implemented by hardware, software and/or a combination thereof. For example, the User interaction module 230 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based User interaction module 230 may be trained by iteratively updating the underlying parameters (e.g., weights 351, 352, etc., bias parameters and/or coefficients in the activation functions 361, 362 associated with neurons) of the neural network based on a loss function. For example, during forward propagation, the training data such as audio and associated text are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding ground-truth text equivalent of a spoken statement) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as new voices.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 3 is exemplary. For example, different neural network structures may be utilized, and additional neural-network based or non-neural-network based component may be used in conjunction as part of module 230. For example, a text input may first be embedded by an embedding model, a self-attention layer, etc. into a feature vector. The feature vector may be used as the input to input layer 341. Output from output layer 343 may be output directly to a user or may undergo further processing. For example, the output from output layer 343 may be decoded by a neural network based decoder. The neural network illustrated in FIG. 300 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 230. The trained neural network thus improves neural network technology in user interactive devices.

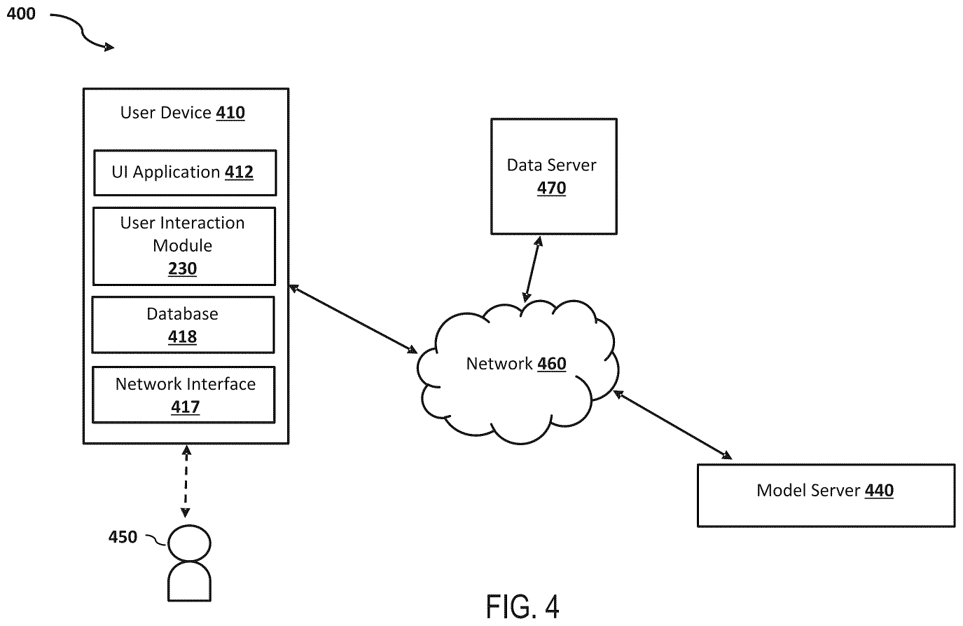

FIG. 4 is a simplified block diagram of a networked system 400 suitable for implementing the framework described herein. In one embodiment, system 400 includes the user device 410 (e.g., computing device 200) which may be operated by user 450, data server 470, model server 440, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 410 is used in training neural network based models. In some embodiments, user device 410 is used in performing inference tasks using pre-trained neural network based models (locally or on a model server such as model server 440).

User device 410, data server 470, and model server 440 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460. User device 410, data server 470, and/or model server 440 may be a computing device 200 (or similar) as described herein.

In some embodiments, all or a subset of the actions described herein may be performed solely by user device 410. In some embodiments, all or a subset of the actions described herein may be performed in a distributed fashion by various network devices, for example as described herein.

User device 410 may be implemented as a communication device that may utilize appropriate hardware and software configured for wired and/or wireless communication with data server 470 and/or the model server 440. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and User interaction module 230, which may correspond to executable processes, procedures, and/or applications with associated hardware. For example, the user device 410 may allow a user to interact with an otherwise one-directional audio and/or video interface. In other embodiments, user device 410 may include additional or different modules having specialized hardware and/or software as required.

In various embodiments, user device 410 includes other applications as may be desired in particular embodiments to provide features to user device 410. For example, other applications may include security applications for implementing client-side security features, programmatic client applications for interfacing with appropriate application programming interfaces (APIs) over network 460, or other types of applications. Other applications may also include communication applications, such as email, texting, voice, social networking, and IM applications that allow a user to send and receive emails, calls, texts, and other notifications through network 460.

Network 460 may be a network which is internal to an organization, such that information may be contained within secure boundaries. In some embodiments, network 460 may be a wide area network such as the internet. In some embodiments, network 460 may be comprised of direct physical connections between the devices. In some embodiments, network 460 may represent communication between different portions of a single device (e.g., a communication bus on a motherboard of a computation device).

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

User device 410 may further include database 418 stored in a transitory and/or non-transitory memory of user device 410, which may store various applications and data (e.g., model parameters) and be utilized during execution of various modules of user device 410. Database 418 may store audio files, etc. In some embodiments, database 418 may be local to user device 410. However, in other embodiments, database 418 may be external to user device 410 and accessible by user device 410, including cloud storage systems and/or databases that are accessible over network 460 (e.g., on data server 470).

User device 410 may include at least one network interface component 417 adapted to communicate with data server 470 and/or model server 440. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 470 may perform some of the functions described herein. For example, data server 470 may store a training dataset including audio samples and associated text, etc. Data server 470 may provide data to user device 410 and/or model server 440. For example, training data may be stored on data server 470 and that training data may be retrieved by model server 440 while training a model stored on model server 440.

Model server 440 may be a server that hosts models described herein. Model server 440 may provide an interface via network 460 such that user device 410 may perform functions relating to the models as described herein (e.g., interaction via audio responses and/or interactions with a virtual avatar). Model server 440 may communicate outputs of the models to user device 410 via network 460. User device 410 may display model outputs, or information based on model outputs, via a user interface to user 450.

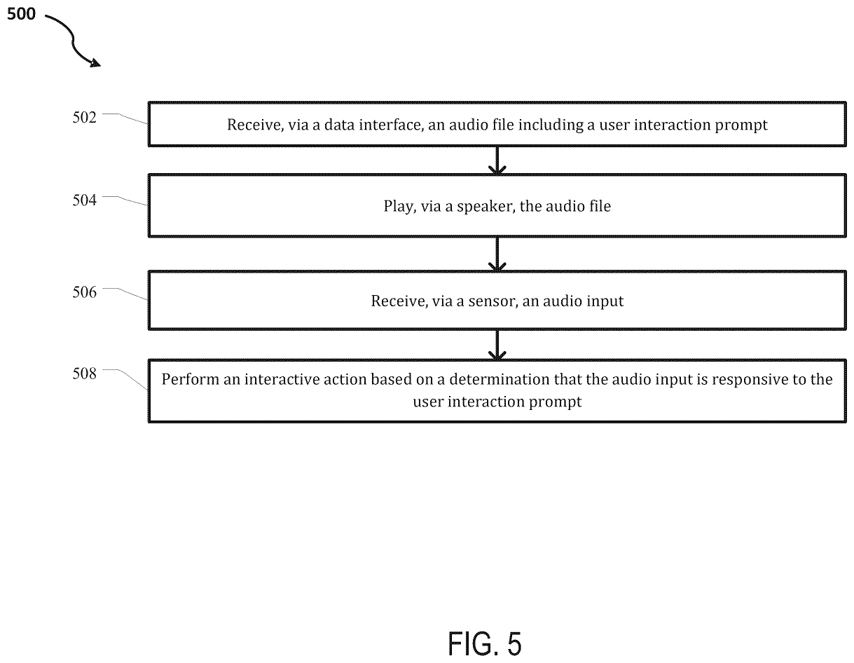

FIG. 5 is an example logic flow diagram, according to some embodiments described herein. One or more of the processes of method 500 may be implemented, at least in part, in the form of executable code stored on non-transitory, tangible, machine-readable media that when run by one or more processors may cause the one or more processors to perform one or more of the processes (e.g., computing device 200). In some embodiments, method 500 corresponds to the operation of the User interaction module 230 that performs audio recognition, user interaction, etc.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a system (e.g., computing device 200, user device 410, model server 440, device 600, or device 615) receives, via a data interface (e.g., data interface 215, network interface 417) an audio file including a user interaction prompt.

At step 504, the system plays, via a speaker, the audio file.

At step 506, the system receives, via a sensor, an audio input.

At step 508, the system performs an interactive action based on a determination that the audio input is responsive to the user interaction prompt. In some embodiments, the user interaction prompt is a prompt to speak a particular phrase. For example, the user interaction prompt may be the spoken phrase “If you want more information, say ‘I want more info’.” In some embodiments, the determination that the audio input is responsive to the user interaction prompt includes determining if the audio input includes the particular phrase. This determination may be based on a neural network based model. In some embodiments, the interactive action includes playing a responsive audio file. For example, the responsive audio file may include additional requested information. In some embodiments, the interactive action includes an additional user interaction prompt. In some embodiments, the interactive action includes transmitting a message to a remote server based on the audio input. The message to the remote server may include a command to send a text message to a phone number associated with the user device. In some embodiments, the interactive action includes launching an audio chat interface. The audio chat interface may also includes a visual display of a virtual avatar.

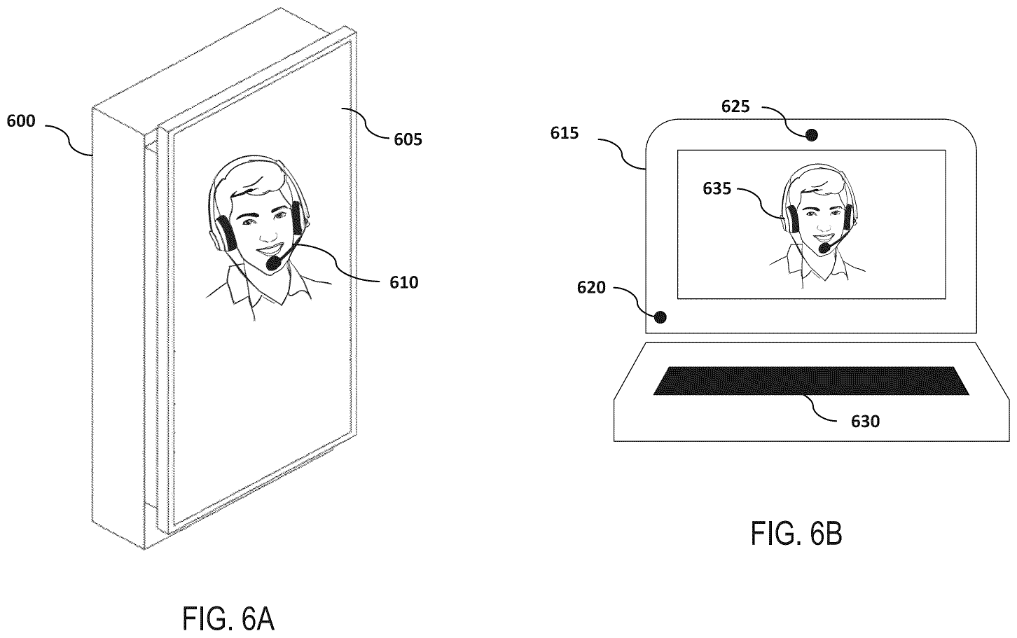

FIG. 6A is an exemplary device 600 with a digital avatar interface, according to some embodiments. Device 600 may be, for example, a kiosk that is available for use at a store, a library, a transit station, etc. Device 600 may display a digital avatar 610 on display 605. In some embodiments, a user may interact with the digital avatar 610 as they would a person, using voice and non-verbal gestures. Digital avatar 610 may interact with a user via digitally synthesized gestures, digitally synthesized voice, etc.

Device 600 may include one or more microphones, and one or more image-capture devices (not shown) for user interaction. Device 600 may be connected to a network (e.g., network 460). Digital Avatar 610 may be controlled via local software and/or through software that is at a central server accessed via a network. For example, an AI model may be used to control the behavior of digital avatar 610, and that AI model may be run remotely. In some embodiments, device 600 may be configured to perform functions described herein (e.g., via digital avatar 610). For example, device 600 may perform one or more of the functions as described with reference to computing device 200 or user device 410. For example, digital avatar 610 may interact with a user in response to an indication from the user that it would like to interact in response to an audio prompt. In some embodiments, additional or alternative information may be displayed via device 600, for example a website landing page may be displayed in response to a user input.

FIG. 6B is an exemplary device 615 with a digital avatar interface, according to some embodiments. Device 615 may be, for example, a personal laptop computer or other computing device. Device 615 may have an application that displays a digital avatar 635 with functionality similar to device 600. For example, device 615 may include a microphone 620 and image capturing device 625, which may be used to interact with digital avatar 635. In addition, device 615 may have other input devices such as a keyboard 630 for entering text.

Digital avatar 635 may interact with a user via digitally synthesized gestures, digitally synthesized voice, etc. In some embodiments, device 615 may be configured to perform functions described herein (e.g., via digital avatar 635). For example, device 615 may perform one or more of the functions as described with reference to computing device 200 or user device 410. For example, digital avatar 635 may interact with a user in response to an indication from the user that it would like to interact in response to an audio prompt. In some embodiments, additional or alternative information may be displayed via device 615, for example a website landing page may be displayed in response to a user input.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for user interaction performed by a user device, the method comprising:
receiving, via a data interface, an audio file including a user interaction prompt;
playing, via a speaker, the audio file;
receiving, via a sensor, an audio input; and
performing an interactive action based on a determination that the audio input is responsive to the user interaction prompt.

2. The method of claim 1, wherein the user interaction prompt is a prompt to speak a particular phrase.

3. The method of claim 2, wherein the determination that the audio input is responsive to the user interaction prompt includes determining if the audio input includes the particular phrase.

4. The method of claim 3, wherein the determination is based on a neural network based model.

5. The method of claim 1, wherein the interactive action includes playing a responsive audio file.

6. The method of claim 5, wherein the interactive action includes an additional user interaction prompt.

7. The method of claim 6, further comprising:
receiving, via the sensor, a second audio input in response to the additional user interaction prompt; and
transmitting a message to a remote server based on the second audio input.

8. The method of claim 7, wherein the message to the remote server includes a command to send a text message to a phone number associated with the user device.

9. The method of claim 1, further comprising:
playing, via a speaker, a second audio file;
receiving, via a sensor, a second audio input; and
performing a second interactive action based on the second audio input.
